(19) United States
(12) Patent Application Publication
(10) Pub. No.: US 2019/0213792 A1
(43) Pub. Date: Jul. 11, 2019

(54) Providing Body-Anchored Mixed-Reality Experiences

(71) Applicant: Microsoft Technology Licensing, LLC, Redmond, WA (US)

(72) Inventors: Kenneth Mitchell JAKUBZAK, Lynnwood, WA (US); Fahrim Ur RAHMAN, Redmond, WA (US)

(21) Appl. No.: 15/867,971

(22) Filed: Jan. 11, 2018

(51) Int. Cl. G06T 19/00; G06F 3/01; G06T 19/20; G02B 27/01; G06T 17/20

(52) U.S. Cl. CPC G06T 19/006; G06F 3/011; G06T 17/20; G02B 27/017; G06T 19/20

(57) ABSTRACT

A mixed-reality technique is described herein that associates an instance of program functionality with an anchoring human body part, such as a user's palm, fingertip, forearm, etc. The technique then presents a virtual object in physical relation to the anchoring body part. The virtual object provides an interface that allows the user to conveniently interact with the program functionality. In some implementations, the technique identifies the body parts of the user by generating a skeleton of the user's body. The technique generates the skeleton, in turn, based on image information captured by one or more cameras. In some implementations, the virtual object that is presented is also associated with a particular person with whom the user has a predefined relationship. The user may interact with the particular person via the virtual object, e.g., by receiving and sending messages from/to the person.

### BACKGROUND

A user sometimes performs several different computer-implemented tasks within a relatively short period of time. The user may rely on two or more different computer programs to perform these tasks. In addition, or alternatively, the user may rely on two or more computer devices to perform these tasks. For instance, a user may interact with a word processing program provided by a desktop computing device to create a document. Simultaneously therewith, the user may occasionally check a communication application provided by his or her smartphone to determine if any new messages have been received.

The user may find it cumbersome, distracting and time-consuming to interrupt a first task provided by a first program to interact with a second task provided by a second program. For instance, this operation may entail locating whatever device provides the second program, hunting for the second program within a data store provided by the device, activating the second program, and then searching for the desired program functionality within the second program. The difficulty of these operations is compounded when the user is unfamiliar with the second program.

### SUMMARY

A mixed-reality technique is described herein that associates an instance of program functionality with an anchoring human body part, such as a user's palm, fingertip, forearm, etc. The technique then presents a virtual object in physical relation to the anchoring body part. The virtual object provides an interface that allows the user to conveniently interact with the program functionality, without unduly distracting the user with respect to other tasks the user may be performing at the same time.

In some implementations, the technique identifies the body parts of the user by generating a skeleton of the user's body. The technique generates the skeleton, in turn, based on image information captured by one or more cameras.

In some implementations, the virtual object that is presented is also associated with a particular person with whom the user has a predefined relationship. The user may interact with the particular person via the virtual object, e.g., by receiving and sending messages from/to the person.

The above-summarized technique can be manifested in various types of systems, devices (e.g., a head-mounted display), components, methods, computer-readable storage media, data structures, user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing environment for presenting a mixed-reality experience.

FIGS. 2-7 show different illustrative user experiences provided by the computing environment of FIG. 1.

FIG. 8 shows one implementation of a skeleton generator component, which is an element of the computing environment of FIG. 1.

FIG. 9 shows an illustrative skeletonized representation of a body of a user, generated by the skeleton generator component of FIG. 8.

FIG. 10 shows one implementation of a virtual experience generator (VEG) component, which is another element of the computing environment of FIG. 1.

FIG. 11 shows an illustrative user interface presentation by which a user can configure the VEG component of FIG. 10.

FIG. 12 shows an example that shows how an application may leverage the computing environment of FIG. 1 to present notifications to a user.

FIG. 13 shows one implementation of a head-mounted display (HMD) that can be used to implement at least parts of the computing environment of FIG. 1.

FIG. 14 shows an illustrative simultaneous location and mapping (SLAM) component, which is an element of the HMD of FIG. 13.

FIG. 15 shows one implementation of illustrative hardware associated with the HMD of FIG. 13.

FIG. 16 shows another computing device that can be used to implement at least parts of the computing environment of FIG. 1, instead of, or in addition to, the HMD.

FIG. 17 shows an alternative mechanism for identifying at least some body parts of the user, instead of, or in addition to, the skeleton generator component of FIG. 8.

FIG. 18 shows yet another alternative mechanism for identifying at least some body parts of the user.

FIG. 19 is a flowchart that shows an illustrative process performed by the skeleton generator component of FIG. 8.

FIG. 20 is a flowchart that shows an illustrative process perform by the VEG component (of FIG. 10) and a virtual experience presentation (VEP) component (which is another element of the computing environment of FIG. 1).

FIG. 21 is a flowchart that shows another process performed by the VEG component and the VEP component.

FIG. 22 shows an illustrative type of computing device that can be used to implement any aspect of the features shown in the foregoing drawings.

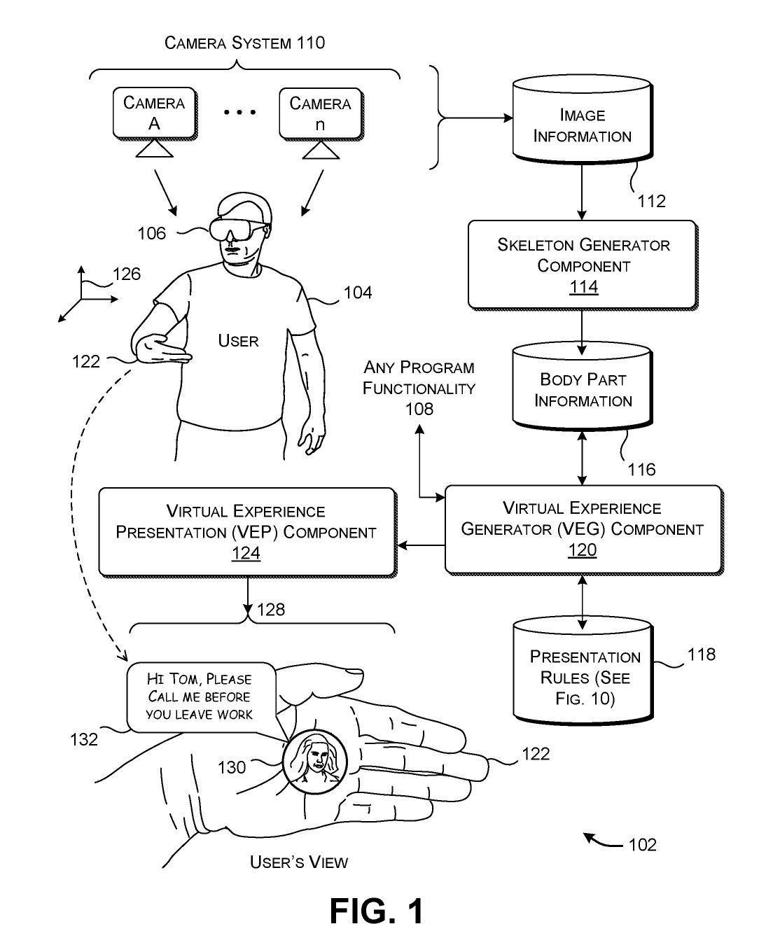

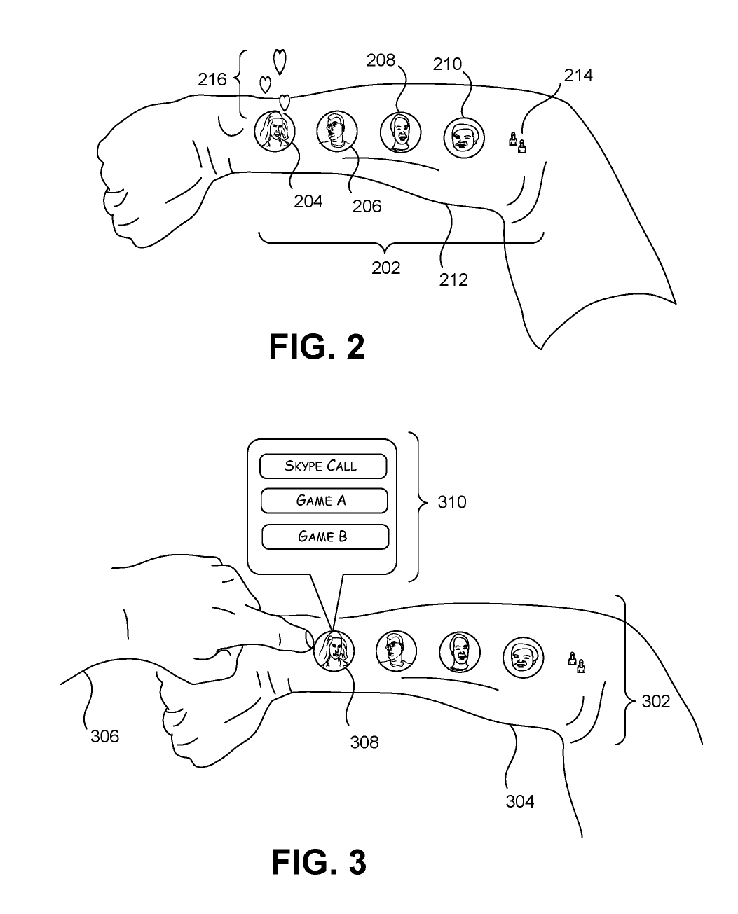

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing environment for presenting virtual objects in physical relation to anchoring body parts. Section B sets forth illustrative methods which explain the operation of the computing environment of Section A. And Section C describes illustrative computing functionality that can be used to implement any aspect of the features described in Sections A and B.

As a preliminary matter, the term “hardware logic circuitry” corresponds to one or more hardware processors (e.g., CPUs, GPUs, etc.) that execute machine-readable instructions stored in a memory, and/or one or more other hardware logic components (e.g., FPGAs) that perform operations using a task-specific collection of fixed and/or programmable logic gates. Section C provides additional information regarding one implementation of the hardware logic circuitry.

The terms “component,” “unit,” “element,” etc. refer to a part of the hardware logic circuitry that performs a particular function. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic components that include a task-specific collection of logic gates.

As to terminology, the phrase “configured to” encompasses various physical and tangible mechanisms for performing an identified operation. The mechanisms can be configured to perform an operation using the hardware logic circuity of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Computing Environment

A.1. Overview

FIG. 1 shows an illustrative computing environment 102 for presenting a mixed-reality experience to a user 104 who moves within a physical environment. The term “mixed-reality” environment encompasses at least augmented reality environments, augmented virtual environments, and entirely virtual environments. In an augmented reality environment, the computing environment 102 adds virtual objects to representations of real-world objects in the physical environment. In an augmented virtual environment, the computing environment 102 adds representations of real-world objects to an otherwise virtual world. In a completely virtual environment, the computing environment 102 provides a completely immersive virtual world, e.g., without reference to real-world objects in the physical environment. But in a completely virtual environment, the computing environment 104 is still responsive to actions taken by a user 104 within the physical environment

Without limitation, in the case of FIG. 1, the computing environment 102 provides the mixed-reality experience using a head-mounted display (HMD) 106. The HMD 106 can produce a mixed-reality experience by projecting virtual objects onto a partially-transparent display device or an opaque (non-see-through) display device. However, the computing environment 102 can use other equipment to produce a mixed-reality experience, as will be explained in Subsection A.7 below.

As used herein, a virtual object broadly refers to any item that constitutes a perceptible entity within a mixed-reality world. In most of the cases described below, the virtual object corresponds has a visual component which the user 104 perceives using a display device provided by the HMD 106 or some other mixed-reality device(s). The virtual object may also include an audio component that the user 104 perceives using one or more microphones provided by the HMD 106 or some other mixed-reality device(s). In yet another case, the virtual object can have just an audio component, without a visual component.

In still another case, the user 104 can perceive the existence of the virtual object in a mixed-reality world by virtue of the observable functions that this object enables the user 104 to perform. In this situation, the virtual object need not have a visual and/or audio counterpart in the mixed-reality world. For example, the virtual object can correspond to key that is associated with a user's index finger. The mixed-reality world in which that key exists may or may not provide a visual representation of the key. To nevertheless facilitate explanation, most of the examples presented below correspond to the case in which the virtual object has a visual manifestation in the mixed-reality world.

Each virtual object provides a mechanism by which a user 104 may interact with some instance of program functionality 108, e.g., corresponding to a system component of an operating system and/or an application. For example, a virtual object may depict a contact card that provides a mechanism by which the user 104 may receive a message from a communication application, such as the SKYPE application provided by MICROSOFT CORPORATION of Redmond, Wash. The user 104 may optionally respond to the message via the same virtual object. In other case, a virtual object may depict a clock, the underlying base functionality of which is provided by a system component of an operating system.

The components of the computing environment 102 can be implemented using the hardware circuitry described in Section C. These components will first be described without reference to the particular device(s) that implement the hardware circuitry. As will be described below, different implementations can use different combinations of devices to implement the hardware logic circuitry.

A camera system 110 includes one or more cameras that capture image information. The camera system 110 then stores the image information in a data store 112. The image information includes a representation of the user 104. For example, the cameras of the camera system 110 can produce separate instances of image information that capture representations of the user 104 from different respective vantage points. In one case, the camera system 110 provides enough image information to reconstruct a complete three-dimensional representation of the user's body. In another case, the camera system 110 provides image information that can only be leveraged to reconstruct a partial representation of the user's body. In some implementations, the cameras of the camera system 110 have fixed respective positions within the physical environment. In other implementations, one or more of the cameras can move within the physical environment.

The camera system 110 can include any combination of: one or more color video cameras (e.g., RGB camera); one or more monochrome video cameras; a depth camera system, etc. The depth camera system can use any technique(s) to produce depth image information, including a time-of-flight technique, a structured light technique, a stereoscopic technique, etc. The time-of-flight technique and the structured light technique involve projecting electromagnetic radiation (e.g., infrared radiation) onto the scene containing the user 104. Each pixel in an instance of depth image information measures the distance between a reference point and a location in the physical environment.

A skeleton generator component 114 produces body part information based on the image information. It then stores the body part information in a data store 116. The skeleton generator component 114 performs this task by identifying the principal anatomical points associated with the user's body, and constructing a skeletonized representation of the user's body based on those points. The skeletonized representation of the user's body constitutes the body part information because it identifies the different parts of the user's body, with respect to any environment-specific degree of anatomical granularity. Subsection A.3 below provides additional information regarding one implementation of the skeleton generator component 114.

A data store 118 provides a collection of rules. Each rule provides information that governs the display of a virtual object. More specifically, each rule specifies: a particular virtual object; the program functionality 108 that is associated with the virtual object; the circumstances in which the virtual object will be presented; the people who are given permission to consume (e.g., see, interact with, etc.) the virtual object; the manner in which the virtual object is constructed, and so on. Each rule also specifies the body part on which (or in physical relation to which) the virtual object is to be presented. This body part is referred to below as an anchoring body part.

A virtual experience generator (VEG) component 120 generates a virtual object for presentation to the user 104 based on at least one applicable rule specified in the data store 118. For example, consider the case in which a message has been received from a communication application, such as the SKYPE application. The SKYPE application can notify the VEG component 120 that the message has been received. In response, the VEG component 120 can generate a virtual object that presents a notification to the user 104, which alerts the user 104 to the fact that the message has been received. The VEG component 120 also includes a mechanism that allows the user 104 to optionally interact with the notification.

In the above example, assume that an applicable rule in the data store 118 indicates that: (1) the communication application is associated with a notification-conveying virtual object (described below); (2) the virtual object should be presented when a message is received from the communication application; (3) the virtual object should be presented on the right palm of the user's hand 122; (4) the virtual object is to be viewable by any user who dons an HMD, etc. Other implementations can vary any aspect of this rule. For example, another implementation can adopt a rule that specifies that the virtual object is to be presented when the user 104 performs a telltale gesture, such as by orienting the palm of his hand 122 such that a normal of the user's hand insects the user's head, with some environment-specified degree of tolerance. In this example, the communication application corresponds to the program functionality 108 that is associated with the virtual object to be presented.

A virtual experience presentation (VEP) component 124 presents the virtual object that has been generated by the VEG component 120. In one implementation, the VEP component 124 can perform this task by ray-casting the virtual object such that it is presented on (or in physical relation to) the intended body part. For example, in one non-limiting case, the skeleton generator component 114 provides information which identifies the location of the anchoring body part with respect to a world coordinate space 126. The HMD 106 includes a tracking component (described below) which also registers its location and orientation within the same world coordinate space 126. Based on this input information, the VEP component 120 projects the virtual object such that it appears to the user 104 on the appropriate anchoring body part.

The non-limiting virtual object 128 shown in FIG. 1 includes an icon 130 associated with a person who sent a message to the user 104. Assume that the user 104 has a predefined relationship with this person, and the user 104 has previously “pinned” this person to a list of favorite contacts within the communication application. The virtual object 128 also includes a representation of a message 132 sent by the person to the user 104. The icon 130 and the message 132 together constitute a notification. Although not shown, the user 104 may interact with the virtual object 128 in any manner, such as by touching the virtual object 128; this action may activate the communication application that received the message 132. The user 104 may then interact with the communication application to respond to the person who sent the message 132.

Generally, the computing environment 102 allows the user 104 to conveniently interact with an instance of program functionality 108. In the above scenario, for instance, the user 104 can receive a notification by simply looking squarely at the palm of his hand 122. This gesture is easy for the user 104 to remember and perform, and provides minimal interference with whatever task the user 104 was performing at the time that the notification was received.

In a first implementation, the HMD 106 implements the VEG component 120, data store 118, and the VEP component 124. One or more separate computing devices implement the camera system 110, the data store 112, the skeleton generator component 114, and the data store 116. In that situation, the cameras of the camera system 110 may be dispersed around a room in which the user 104 moves using the HMD 106, e.g., at fixed positions. In that case, the cameras of the camera system 110 are calibrated with the cameras of the HMD 106 (described below), such that locations in the world coordinate space 126 identified by the camera system 110 correspond to the same locations identified by the HMD's cameras.

In a second implementation, the HMD 106 implements all of the components shown in FIG. 1. Note that, in this case, the skeleton generator component 114 may be able to generate only a skeletonized representation of some of the user's body parts, such as the user's hands and arms. This is because the cameras of the camera system 110 are affixed to the HMD 106, which prevents them from capturing image information that depicts the entire body of the user 104.

In a third implementation, the equipment associated with the camera system 110, data store 112, skeleton generator 114, and/or data store 116 can be distributed between the HMD 106 and one or more separate computing devices. For example, the skeleton generator component 114 can rely on some image information captured by the HMD's camera(s), and other image information captured one or more separate external cameras.

The above-described implementations are set forth by way of illustration, not limitation. Other implementations can allocate the components shown in FIG. 1 to other combinations of devices.

A.2. Example User Experiences

FIGS. 2-7 show different illustrative user experiences provided by the computing environment 102 of FIG. 1. Beginning with FIG. 2, the computing environment 102 of FIG. 1 presents a composite virtual object that includes a set of child virtual objects. The composite virtual object provides an interface that allows a user to interact with a people-related program. In general, the people-related program provides functionality that allows a user to identify a group of people with whom the user has predefined relationships (referred to as “pinned contacts”) and then interact with those contacts in a convenient manner.

More specifically, the composite virtual object corresponds to a people bar 202. The child virtual objects correspond to an array of icons (204, 206, 208, 210) linearly arrayed along the outer right forearm 212 of the user 104. Each icon, in turn, is associated with a particular person with whom the user has a predefined relationship. A generic icon 214 provides a control feature which the user 104 may activate to interact with the people-related program. For instance, the user may activate this icon 214 to call up a control user interface presentation (not shown) provided by the people-related program; the user may then interact with the control user interface presentation to perform various maintenance tasks pertaining to the people bar 202, such as by adding a new person (together with that person's associated icon) to the people bar 202, etc.

In one implementation, the people bar 202 presents a notification 216 in response to the following illustrative series of operations performed by the computing environment 102: (1) a communication application (such as the SKYPE application) receives a message from a sender; (2) the communication application alerts the people-related program of the arrival of the message; and (3) the people-related program works in cooperation with the VEG component 120 and the VEP component 124 to present the notification 216. Here, the received message corresponds to a heart emoji, and the notification 216 corresponds to a corresponding bubbling heart animation. The animation can be implemented in any manner, such as by executing an animated GIF. Subsection A.5 (below) provides further information regarding the above-summarized series of operations. The notification 216 itself corresponds to a virtual object.

In one case, the data store 118 stores a first rule that controls the presentation of the people bar 202 as a whole. In this case, the first rule specifies that the people bar 202 is to be displayed on the outer right forearm 212 of the user 104. The data store 118 can also store child rules associated with individual icons (204, 206, 208, 210) in the people bar 202. Each child rule controls the presentation of each icon in the people bar 202.

FIG. 3 shows an example in which the computing environment 102 again presents a people bar 302 that includes a set of icons on the outer right forearm 304 of the user 104. Again assume that the people bar 302 serves as an interface for interacting with the people-related program. Further assume that the user 104 uses his left hand 306 to touch an icon 308 associated with a particular person.

The VEG component 120 detects the above-noted touch gesture performed by the user 104. For example, the VEG component 120 can determine that the user 104 performs this gesture when it detects that a body part associated with a user's finger moves within a prescribed environment-specific distance of the icon 308. In response, the people-related program in cooperation with the VEG component 120 and the VEP component 124 present a virtual user interface panel 310 in proximity to the icon 308. The virtual user interface panel 310 includes plural control options. The user 104 may invoke one of these control options (e.g., by touching it) to activate a particular mode of interaction with the person associated with the icon 308. Each mode of interaction is hosted by a particular application.

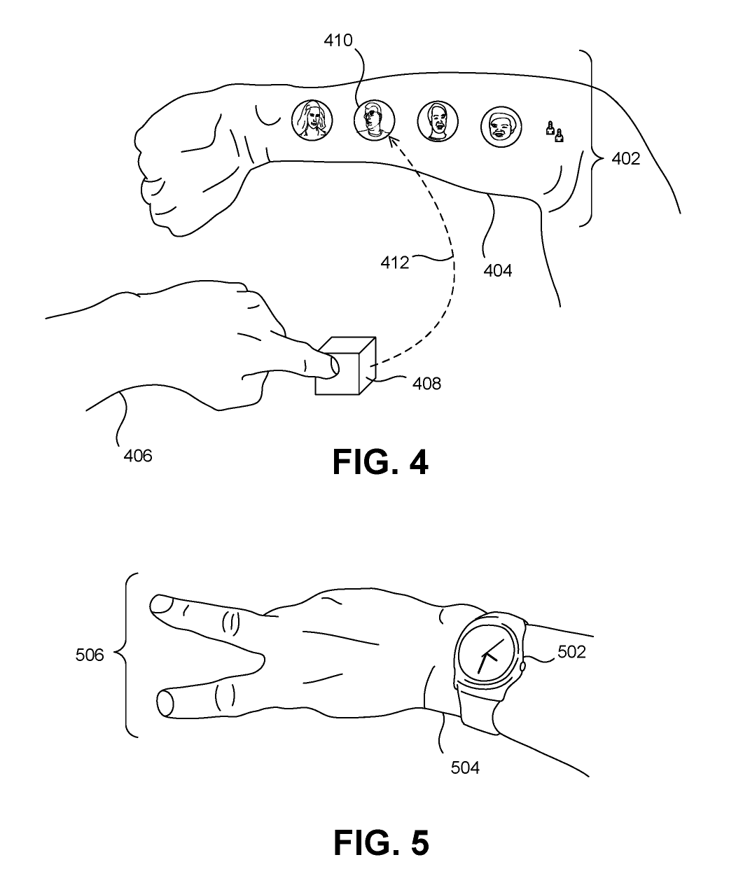

FIG. 4 shows an example in which the computing environment 102 again presents a people bar 402 that includes a set of icons on the right outer forearm 404 of the user 104. Again assume that the people bar 402 serves as an interface for interacting with the people-related program. In this case, further assume that the user 104 uses his left hand 406 to touch a virtual object 408 in the mixed-reality environment (as the mixed-reality environment is visible to the user 104 via the HMD 106). Assume that the user 104 next drags that virtual object 408 to within an environment-specific distance of an icon 410 in the people bar 402. A path 412 depicts the trajectory of the user's dragging operation. The virtual object 408 can correspond to an icon associated with an underlying document, audio file, three-dimensional model, etc., or any combination thereof.

The VEG component 120 detects the above-described gesture performed by the user 104, e.g., by detecting that the user 104 has placed a body part associated with a finger on a virtual object, and then moved that finger to within an environment-specific distance of the icon 410. In response, the people-related program in cooperation with the VEG component 120 transfers a data item to the person associated with the icon 410. The data item corresponds to whatever digital content is associated with the virtual object 408, e.g., corresponding to a document, three-dimensional model, etc.

The recipient may perform any action with respect to the data item that he receives from the user 104. For example, the recipient may use his own HMD (not shown) to reconstitute the virtual object in his own mixed-reality environment. In this situation, the user 104 and the recipient may be interacting with a shared mixed-reality world, or different respective mixed-reality worlds.

FIG. 5 shows an example in which a system clock component interacts with the VEG component 120 and the VEP component 124 to present a virtual object associated with a watch 502. The underlying rule associated with this scenario instructs the VEP component 124 to present the watch 502 on the right wrist 504 of the user 104. Further, the rule specifies that the VEP component 124 should only present the watch 502 when the user 104 performs a gesture with two extended fingers 506, forming a “peace sign.” Accordingly, the user 104 will perceive the watch 502 as vanishing when he ceases performing this telltale gesture.

The rule also defines the outward appearance of the watch 502 by specifying a skin component. In one implementation, a skin component may correspond to a texture image. The VEG component 120 produces the appearance of the watch 502 by pasting the texture image onto a base three-dimensional model that describes the shape of the watch. In another implementation, a skin component may correspond to a selected texture image in combination with a selected three-dimensional model. In both cases, the system clock component provides program code that implements the time-keeping operations associated with the watch 502. In other words, the watch 502 as a whole can be conceptualized as a skin component that describes the appearance of the watch 502 together with a base component that describes the underlying functions that it performs.

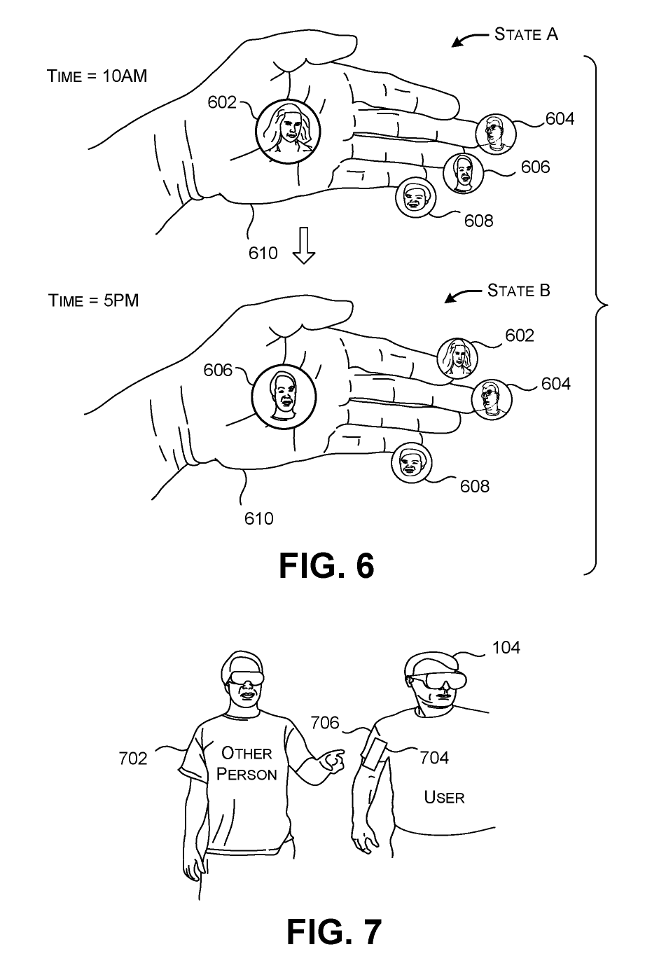

FIG. 6 shows a case in which a people bar corresponds to an array of icons (602, 604, 606, 608) associated with the fingertips of the user's left hand 610. The people bar also presents a heightened-focus icon on the user's palm, corresponding to an icon to which the user 104 is expected to give heighten attention, relative to the other icons. The people bar again serves as an interface for interacting with the people-related program.

A rule associated with the people bar dynamically controls the association between the icons (602, 604, 606, 608) and different parts of the user's hand 610, depending on one or more contextual factors. Here, assume that the sole contextual factor is time of day. In state A, corresponding to a first time of day, the illustrative rule instructs the VEP component 124 to present the icon 602 on the user's palm. In state B, corresponding to a second time of day, the rule instructs the VEP component 124 to present the icon 606 in the user's palm. More generally, FIG. 6 is an example of the more general case in which the computing environment 102 dynamically modifies any aspect of a virtual object (its position, size, color, etc.) in response to one or more contextual factors. Other contextual factors can include: a current location of the user 104; actions currently being performed by the user 104; the habits and preferences of the user 104; actions performed by the people associated with the icons (602, 604, 606, 608), and so on.

The above-described examples show cases in which a user 104 may interact with virtual objects presented in relation to respective body parts. FIG. 7, by contrast, shows an example in which a person 702 (besides the user 104) can interact with a virtual object associated with a body part of the user 104. Here, the virtual object corresponds to a contact book 704 hosted by a contact-related application, and the body part of the user 104 corresponds to the user's upper right arm 706. A rule associated with the virtual object controls whether the person 702 is allowed to see the virtual object, and whether that person 702 is allowed to interact with the virtual object. The VEG component 120 in conjunction with the contact-related application perform an environment-specific action in response to the person's interaction with the virtual object. In the case of FIG. 7, a contact book application or system component may add a digital contact card associated with the person 702 to the user's list of contacts (provided in a contact store) when the person 702 touches the contact book 704 of the user 104. In some cases, the VEG component 120 and/or the contact-related application respond to such an action in different ways depending on the identity of the user who performs the action, e.g., by allowing only a defined class of people to add contact information to the user's contact book 704. In a mirror-opposite scenario, the user 104 can touch a contact book (not shown) associated with a body part of the other person 702; the environment 102 would respond by transferring a contact card associated with the person 702 to the contact store associated with the user 104.

In all of the scenarios described above, the virtual object that is presented includes at least a visual component that is visible to the user 104 and/or one or more other people. In other cases, the virtual object can have both a visual component and an audio component. In other cases, the virtual object can have just an audio component.

In still other cases, the computing environment 102 can provide a virtual object that has neither a visual nor audio component. The user 104 may perceive the existence of the virtual object in the mixed-reality world by virtue of the operations that it enables the user 104 to perform in the mixed-reality world. For example, in the case of FIG. 7, a rule may associate the index finger of the person 702 with a virtual key, which, in turn, is associated with an underlying security-related application. Assume that the virtual key is associated with predetermined credentials of the person 702, as defined by the security-related application. The person 702 can use the virtual key to gain access to a physical space or other asset. For instance, the person 702 can use the key by drawing it within prescribed proximity to a digital lock on a door. The VEG component 120 and the VEP component 124 may or may not provide a visual representation of the virtual key to the person 702. In the latter case, the person 702 can utilize the virtual key without an HMD or like device. In another example, the user's upper right arm 706 in FIG. 7 may be associated with a virtual contact book, without actually showing a visual manifestation of the contact book.

A.3. The Skeleton Generator Component

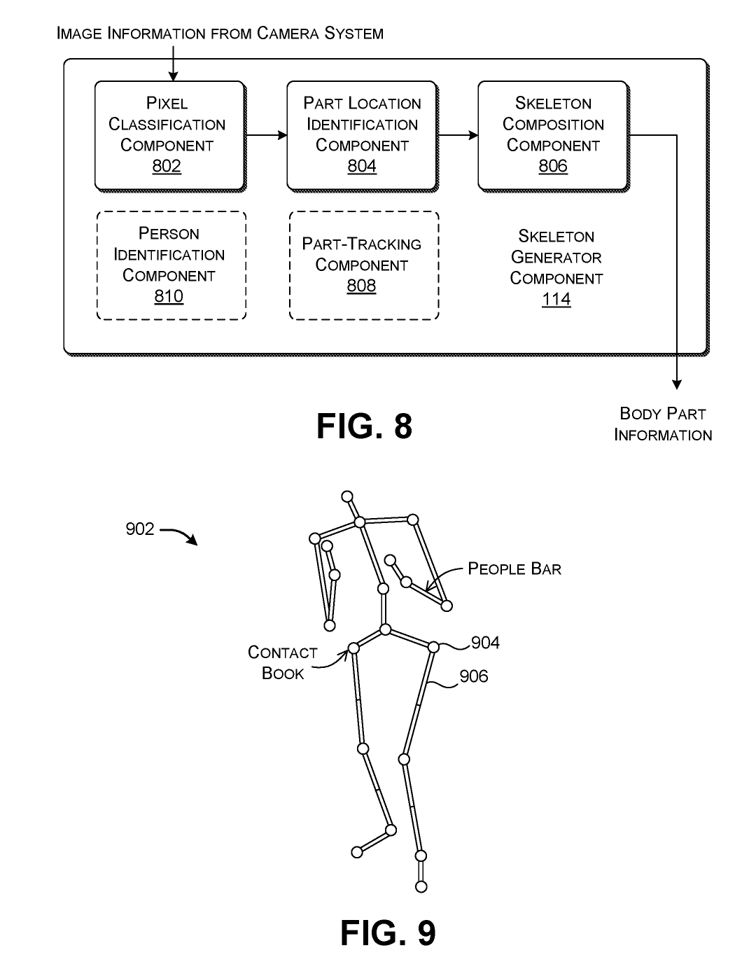

FIG. 8 shows one implementation of the skeleton generator component 114. As introduced in Subsection A.1, the purpose of the skeleton generator component 114 is to generate a skeletonized representation of the body of the user 104 in its current state. The skeletonized representation, in turn, constitutes the body part information. The skeleton generator component 114 receives as input image information from the camera system 110. Assume in this example that the image information corresponds to an instance of depth image information produced by at least one depth camera system.

A pixel classification component 802 classifies each pixel of the input image information with respect to its most likely body part. The pixel classification component 802 can perform this task by first generating a set of features associated with each pixel. In one case, the pixel classification component 802 generates the features using the equation:

$${f}_{θ} ( I , x ) = {d}_{I} ( x + \frac{u}{{d}_{I} ( x )} ) - {d}_{I} ( x + \frac{v}{{d}_{I} ( x )} ) .$$

The term d_{I}(x) corresponds to the depth of a pixel x (defined with respect to two dimensions) within an image I. The terms u and v correspond to two pixels having respective offset positions from the pixel x. The above equation gives a feature f_{θ} for a particular combination θ=(u, v). The pixel classification component 802 generates the set of features based on different instantiations of θ.

The pixel classification component 802 can then use a machine-learned model to map the set of features for each pixel into a classification of the pixel. For instance, without limitation, the pixel classification component 802 can use a random forest machine-learned model to perform this task. The classification of a pixel indicates the body part to which the pixel most likely belongs.

A part location identification component 802 determines a representative location associated with each body part. It performs this task based on the per-pixel classifications provided by the pixel classification component 802. A subset of these locations corresponds to skeletal joints, such as elbows, knees, shoulders, etc. Other locations are not necessarily associated with a joint, such as a location associated with “upper torso.”

In one approach, the part location identification component 804 uses a clustering technique to identify a representative location within a set of pixels that have been classified as belonging to a same body part. For example, the part location identification component 804 can use a mean shift technique to perform this task. This approach involves: moving a window to an initial location within an image; determining a center of mass with respect to pixels in the window that have been classified as belonging to a particular body part; moving the window so that its center corresponds to the thus-determined center of mass; and repeating this operation. Eventually, the mean shift technique will move the window to a location at which its center of mass corresponds to the center of the window. This defines the representative location of the body part under consideration.

A skeleton composition component 806 generates a skeleton based on the locations identified by the part location identification component 804. The skeleton composition component 806 can perform this task by linking the locations together to create the skeleton.

The above approach is one of many different skeleton-generating techniques that can be used to generate the skeleton. Additional information regarding the general topic of skeleton generation is provided in: Published U.S. Patent Application No. 20110317871 to Tossell, et al., entitled “Skeletal Joint Recognition and Tracking System,” published on Jun. 28, 2012; and Published U.S. Patent Application No. 20110268316 to Bronder, et al., entitled “Multiple Centroid Condensation of Probability Distribution Clouds,” published on Nov. 3, 2011.

An optional part-tracking component 808 can use any tracking technique to assist in tracking the movement of already-identified part locations. For example, the part-tracking technique can use a Kalman filter, a particle filter, etc. in performing this task.

An optional person identification component 810 can identify the user 104. In one approach, the person identification component 810 learns of the identity of the user 104 based on identity information passed by the user's HMD 106 at the start of a mixed-reality session (assuming that the HMD 106 is registered for use by a single user 104). In another case, the user 104 may explicitly provide credentials which identify him or her. In another case, the person identification component 810 can identify the user 104 based on known face recognition technology, voice recognition technology, etc.

Assume that another person (besides the user 104) interacts with the user 104, e.g., by touching a virtual object associated with a body part of the user 104. In that case, the person identification component 810 can learn of the identity of that other person using any of the techniques described above.

FIG. 9 shows an illustrative skeletonized representation 902 of a user's body, generated by the skeleton generator component 114 of FIG. 8. The skeleton includes a collection of joint body parts (such as illustrative joint body part 904) and non-joint body parts (such as illustrative non-joint body part 906). Other implementations can partition a human body into additional (or fewer) body parts compared to the example shown in FIG. 9. For example, another implementation can identify body parts associated with individual fingers of the user's hands. Another implementation can distinguish between different subparts of a body part, such as by labeling the outer and inner portions of the user's forearm. In one implementation, the skeleton generator component 114 stores information regarding each body part by identifying its name (corresponding to any label assigned thereto) along with its current pose (location and orientation) in the world coordinate space 126.

Finally, FIG. 9 indicates that one non-limiting rule associates a contact book with a body part associated with the user's right upper hip. Another non-limiting rule associates a people bar with the user's left outer forearm.

A.4. The Virtual Experience Generator Component

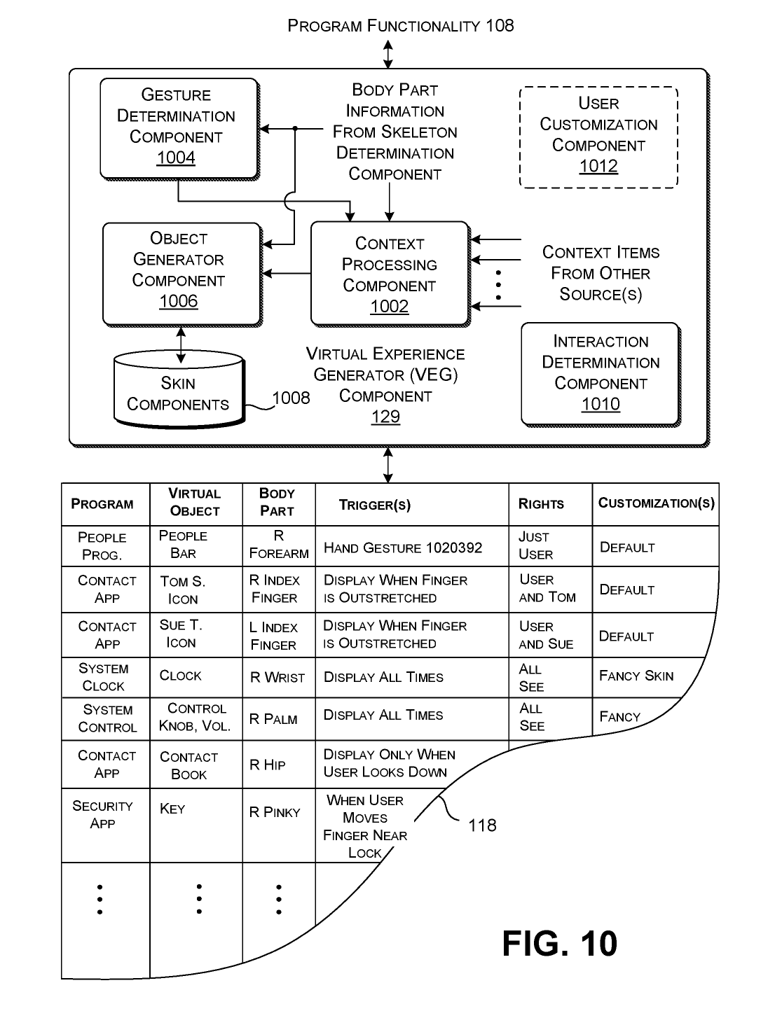

FIG. 10 shows one implementation of the virtual experience generator (VEG) component 120 introduced in FIG. 1. The VEG component 120 interacts with one or more rules provided in a data store 118. Each rule governs the conditions under which a particular virtual object is presented, and the manner in which it is presented. Each rule also defines the relationship between the virtual object and its hosting program functionality.

A context processing component 1002 determines whether a particular virtual object is to be presented based on a corresponding rule in the data store 118. To perform this task, the context processing component 1002 receives context-related information (referred to herein as context items) from one or more sources. One such source is a gesture determination component 1004. The gesture determination component 1004 determines whether the user 104 has performed a telltale gesture specified by a rule. Other sources of context information include a position-determining device (e.g., a GPS device) which determines the current location of the user 104, a digital clock which identifies the current time, and so on

More specifically, the gesture determination component 1004 can detect gestures using custom algorithms and/or machine-learned models. For example, the gesture determination component 1004 can determine that the user 104 has performed the “peace sign” in FIG. 5 by determining whether the user's right hand includes two outstretched fingers, and whether those two outstretched fingers are separated by more than an environment-specific threshold angle. The gesture determination component 1004 can detect dynamic gestures using a recursive neural network (RNN), a hidden Markov model (HMM), a finite state machine, etc.

An object generator component 1006 composes each virtual object. In one case, the object generator component produces the virtual object by combining a skin component with a base component provided by an application or system component. A data store 1008 may store the skin components. As described above, a skin component can correspond to a texture image, a three-dimensional model, etc., or any combination thereof. In some cases, the texture image can specify branding information pertaining to an application, such as a logo.

An interaction determination component 1010 detects whether the user 104 (or another person) has interacted with a virtual object once it is displayed (if in fact it is displayed). The interaction determination component 1010 can rely on the gesture determination component 1004 to perform this task. A rule associated with a virtual object determines the extent to which any person is allowed to interact with a virtual object, and the manner in which the person may perform this interaction.

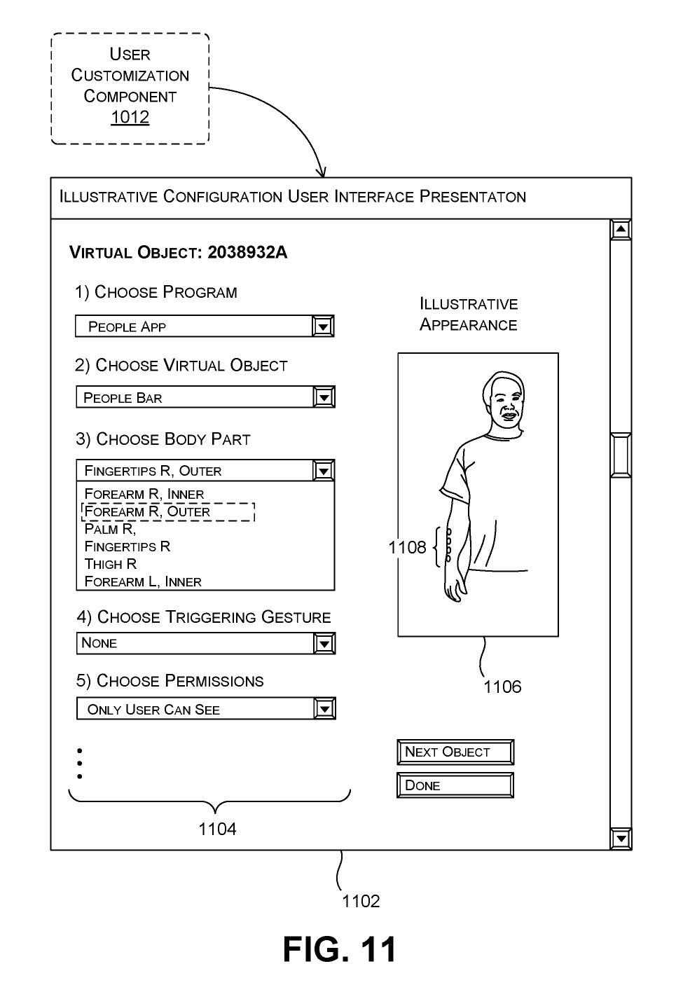

A user customization component 1012 allows the user 104 to produce custom rules for storage in the data store 118. For instance, advancing to FIG. 11, this figure shows an illustrative user interface presentation 1102 provided by the user customization component 1012. The user 104 may interact with this user interface presentation 1102 via the HMD 106 and/or via a separate computing device (not shown).

The user interface presentation 1102 includes a plurality of input mechanisms 1104 (here, drop-down selection menus) that allow the user 104 to specify different aspects of a rule that is associated with an illustrative virtual object. The aspects include: an identity of the program functionality that underlies the virtual object; an identity of the virtual object; an indication of whether the virtual object is visible; an anchoring body part to be associated with the virtual object; a triggering gesture that will invoke the virtual object (if any); permissions that govern who is able to see and/or interact with the virtual object; the interactive properties of the virtual object, and so on. An illustrative panel 1106 provides an example of the appearance of the virtual object 1108 that will be presented to the user 104, when the conditions associated with the virtual object have been met.

A.5. Use in Conjunction with an Illustrative Application

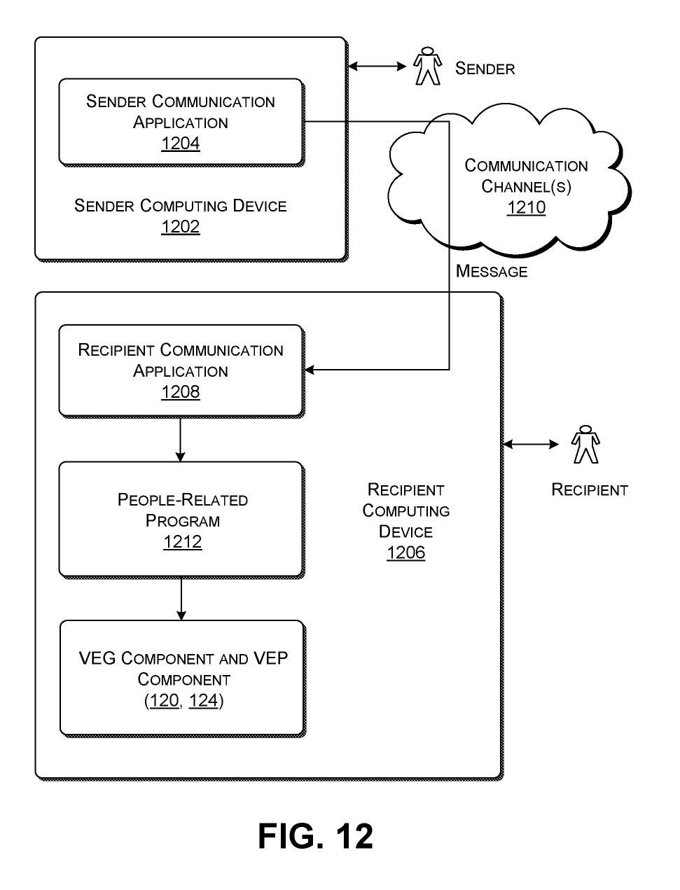

FIG. 12 shows an example that demonstrates how a communication application in cooperation with a people-related program may leverage the computing environment 102 of FIG. 1 to present notifications to the user 104. A sender computing device 1202 hosts a sender communication application 1204 (such as a sender's version of the SKYPE application), while a recipient computing device 1206 (such as the HMD 106) hosts a recipient communication application 1208 (such as a recipient's version of SKYPE). A communication channel 1210 (such as the Internet, a local BLUETOOTH communication path, etc.) communicatively couples the sender computing device 1202 and the recipient computing device 1206.

Assume that the sender interacts with the sender communication application 1204 to send a message to the recipient communication application 1208 via the communication channel 1210. The recipient communication application 1208 then calls the people-related program 1212. The people-related program 1212 then works in cooperation with the VEG component 120 and the VEP component 124 to present a virtual object that notifies the recipient of the sender's message, e.g., in the manner shown in FIG. 2. The recipient can reply by interacting with the virtual object, upon which the above-described components of the recipient computing device 1206 cooperate to send a reply message to the sender communication application 1204.

In the example of FIG. 12, the virtual object serves as an interface for interacting with the people-related program 1212. In other examples, a virtual object may serve as an interface for directly interacting with the recipient communication application 1208. In other examples, a virtual object may serve as an interface for interacting with a system component of an operating system, etc.

A.6. Implementation Using a Head-Mounted Display

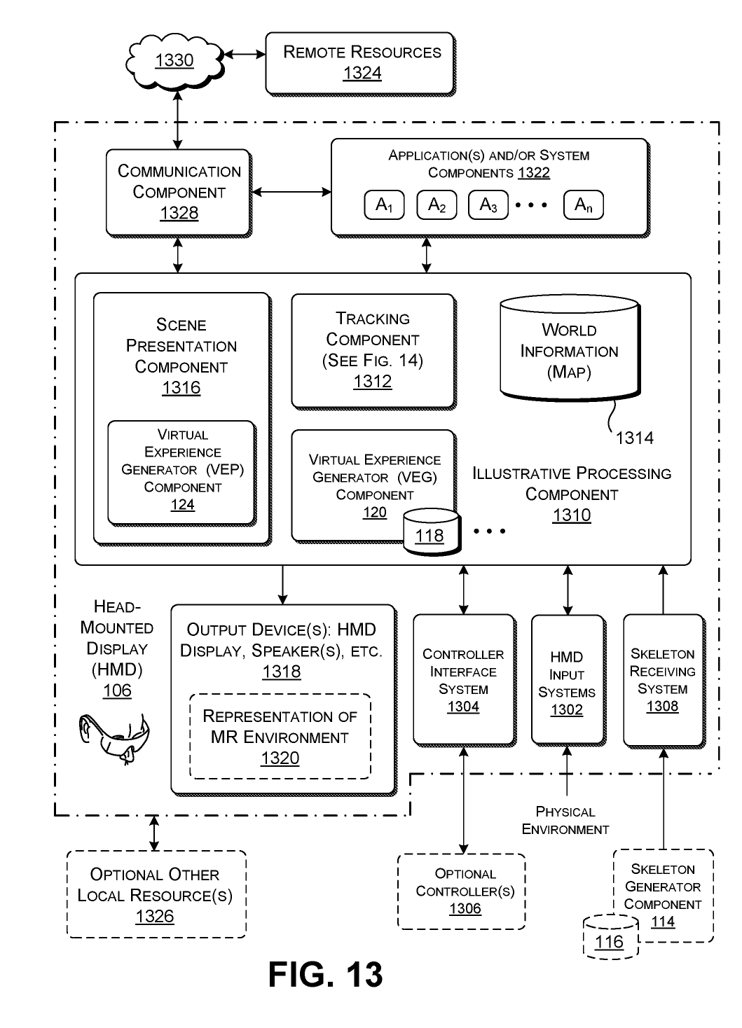

FIG. 13 shows a more detailed depiction of the head-mounted display (HMD) 106 introduced in Subsection A.1. In this example, assume that the HMD 106 implements the VEG component 120, the data store 118, and the VEP component 124. One or more other devices implement the other components shown in FIG. 1, including the skeleton generator component 114. But in another implementation, the HMD 106 implements all of the components shown in FIG. 1.

The HMD 106 includes a collection of input systems 1302 for interacting with a physical environment. The input systems 1302 can include, but are not limited to: one or more environment-facing video cameras; an environment-facing depth camera system; a gaze-tracking system; an inertial measurement unit (IMU); one or more microphones; a speech recognition system, etc.

Each video camera may produce red-green-blue (RGB) image information and/or monochrome grayscale information. The depth camera system produces depth image information based on image information provided by the video cameras. Each pixel of the depth image information represents a distance between a reference point associated with the HMD 106 and a point in the physical environment. The depth camera system can use any technology to measure the depth of points in the physical environment, including a time-of-flight technique, a structured light technique, a stereoscopic technique, etc., or any combination thereof.

In one implementation, the IMU can determine the movement of the HMD 106 in six degrees of freedom. The IMU can include one or more accelerometers, one or more gyroscopes, one or more magnetometers, etc., or any combination thereof.

The gaze-tracking system can determine the position of the user's eyes and/or head. The gaze-tracking system can determine the position of the user's eyes, by projecting light onto the user's eyes, and measuring the resultant glints that are reflected from the user's eyes. Illustrative information regarding the general topic of eye-tracking can be found, for instance, in U.S. Patent Application No. 20140375789 to Lou, et al., entitled “Eye-Tracking System for Head-Mounted Display,” and published on published on Dec. 25, 2014. The gaze-tracking system can determine the position of the user's head based on IMU information supplied by the IMU.

The speech recognition system can receive and analyze voice signals provided by the microphone(s), e.g., using a neural network. The HMD 106 can leverage the speech recognition system to interpret commands spoken by the user 104.

An optional controller interface system 1304 handles interaction with one or more controllers 1306. For example, a controller can correspond to a device which the user 104 manipulates with a hand, a body-worn device, etc. The controller interface system 1304 can interact with a controller, for instance, based on electromagnetic radiation and/or magnetic fields emitted by the controller. The controller interface system 1304 can also interact with the controller through a separate local data channel, such as a BLUETOOTH channel, a WIFI channel etc.

A skeleton receiving system 1308 receives body part information from the skeleton generator component 114. The skeleton receiving system 1308 can receive this information through any type of separate local communication channel, such as a BLUETOOTH channel, a WIFI channel, etc.

A collection of processing components 1310 process the input information provided by the input systems 1302, the controller interface system 1304, and the skeleton receiving system 1308, to provide a mixed-reality experience. For instance, a tracking component 1312 determines the pose of the HMD 106 in the physical environment, corresponding to its x, y, and z position, and its orientation within the world coordinate space 126. In one implementation, the tracking component 1312 can determine the pose of the HMD 106 using simultaneous localization and mapping (SLAM) technology. The SLAM technology progressively builds a map of the physical environment. Further, at each instance, the SLAM technology determinates the pose of the HMD 106 with respect to the map in its current state. A data store 1314 stores the map in its current state. The map is also referred to herein as map information or world information.

Although not denoted in FIG. 13, a surface reconstruction component identifies surfaces in the mixed-reality environment based, in part, on input information provided by the input systems 1302. The surface reconstruction component can then add surface information regarding the identified surfaces to the world information provided in the data store 1314.

In one approach, the surface reconstruction component can identify principal surfaces in a scene by analyzing 2D depth image information captured by the HMD's depth camera system at a current time, relative to the current pose of the user 104. For instance, the surface reconstruction component can determine that a given depth value is connected to a neighboring depth value (and therefore likely part of the same surface) when the given depth value is no more than a prescribed distance from the neighboring depth value. Using this test, the surface reconstruction component can distinguish a foreground surface from a background surface. The surface reconstruction component can improve its analysis of an instance of depth image information using any machine-trained pattern-matching model and/or image segmentation algorithm. The surface reconstruction component can also use any least-squares-fitting techniques, polynomial-fitting techniques, patch-assembling techniques, etc. Alternatively, or in addition, the surface reconstruction component can use known fusion techniques to reconstruct the three-dimensional shapes of objects in a scene by fusing together knowledge provided by plural instances of depth image information.

Illustrative information regarding the general topic of surface reconstruction can be found in: U.S. Patent Application No. 20110109617 to Snook, et al., entitled “Visualizing Depth,” published on May 12, 2011; U.S. Patent Application No. 20130106852 to Woodhouse, et al., entitled “Mesh Generation from Depth Images,” published on May 2, 2013; U.S. Patent Application No. 20160027217 to da Veiga, et al., entitled “Use of Surface Reconstruction Data to Identity Real World Floor,” published on Jan. 28, 2016; and U.S. Patent Application No. 20160364907 to Schoenberg, entitled “Selective Surface Mesh Regeneration for 3-Dimensional Renderings,” published on Dec. 15, 2016.

A scene presentation component 1316 can use graphics pipeline technology to produce a three-dimensional (or two-dimensional) representation of the mixed-reality environment. The scene presentation component 1316 generates the representation based at least on virtual content provided by various program sources, together with the world information in the data store 1314. The graphics pipeline technology can performing processing that includes vertex processing, texture processing, object clipping processing, lighting processing, rasterization, etc. Overall, the graphics pipeline technology can represent surfaces in a scene using meshes of connected triangles or other geometric primitives. The scene presentation component 1316 can also produce images for presentation to the left and rights eyes of the user 104, to produce the illusion of depth based on the principle of stereopsis.

The scene presentation component 1316 also presents the virtual objects provided by the VEG component 120. As noted above, the VEP component 124 can perform this task by projecting a virtual object onto its anchoring body part. The identity of the anchoring body part is specified in the data store 118 (e.g., corresponding to the user's right forearm), while the current x, y, z position and orientation of the anchoring body part in the world coordinate space 126 is specified by the skeleton generator component 114. The tracking component 1312 identifies the current pose of the HMD 106 within the world coordinate space 126.

The scene presentation component 1316 can correctly place the virtual object on the appropriate body part when the cameras of the HMD 106 are calibrated with respect to the cameras of the camera system 110, with reference to the same world coordinate space 126. To further improve the accuracy of placement, the scene presentation component 1316 can snap a virtual object to the nearest surface of the user's body, where such surface is identified by the surface reconstruction component. For example, consider the illustrative case in which the anchoring body part corresponds to the user's right forearm, and in which the location of the user's forearm as reported by the skeleton generator component 114 is 2 cm above or below the nearest surface of the user's body as reported by the HMD's surface reconstruction component. In this situation, scene presentation component 1316 can shift the virtual object so that it rests on the nearest surface of the user's body, as reported by the surface reconstruction component.

One or more output devices 1318 provide a representation 1320 of the mixed-reality (MR) environment. The output devices 1318 can include any combination of display devices, such as a liquid crystal display panel, an organic light emitting diode panel (OLED), a digital light projector, etc. More generally, in one implementation, the output devices 1318 can include a semi-transparent display mechanism. That mechanism provides a display surface on which virtual objects may be presented, while simultaneously allowing the user 104 to view the physical environment “behind” the display surface. The user 104 perceives the virtual objects as being overlaid on the physical environment and integrated with the physical environment. In another implementation, the output devices 1318 include an opaque (non-see-through) display mechanism for providing a fully immersive virtual display experience. An opaque display mechanism shows a representation of the real world by presenting a digital representation of the real world, e.g., as produced by one or more video cameras and/or the surface reconstruction component, with virtual objects added thereto.

The output devices 1318 may also include one or more speakers. The HMD 106 can use known techniques (e.g., using a head-related transfer function (HRTF)) to provide directional sound information to the speakers, which the user 104 perceives as originating from a particular pose within the physical environment.

The HMD 106 can include a collection of local applications and/or system components 1322, stored in a local data store (generically referred to previously as program functionality 108). Each local application and/or system component can perform any function, examples of which were identified above.

Note that FIG. 13 indicates that the above-described components are housed within a single physical unit associated with the HMD 106. While this represents one viable implementation of the HMD 106, in other cases, any of the functions described above can alternatively, or in addition, be implemented by one or more remote resources 1324 and/or one or more local resources 1326. Similarly, any of the information described above can alternatively, or in addition, be stored by the remote resources 1324 and/or the local resources 1326. The remote resources 1324 may correspond to one or more remote servers and/or other remote processing devices. The local resources 1326 may correspond to one or more processing devices that are located within the same physical environment as the HMD 106. For example, a local processing device may correspond to a device that the user 104 fastens to his or her belt. In view of the above, what is referred to herein as the HMD 106 may encompass processing components distributed over any number of physical processing devices.

A communication component 1328 allows the HMD 106 to interact with the remote resources 1324 via a computer network 1330. The communication component 1328 may correspond to a network card or other suitable communication interface mechanism. The computer network 1330 can correspond to a local area network, a wide area network (e.g., the Internet), one or more point-to-point links, etc., or any combination thereof. The HMD 106 can interact with the optional local resources 1326 through any communication mechanism, such as BLUETOOH, WIFI, a hardwired connection, etc.

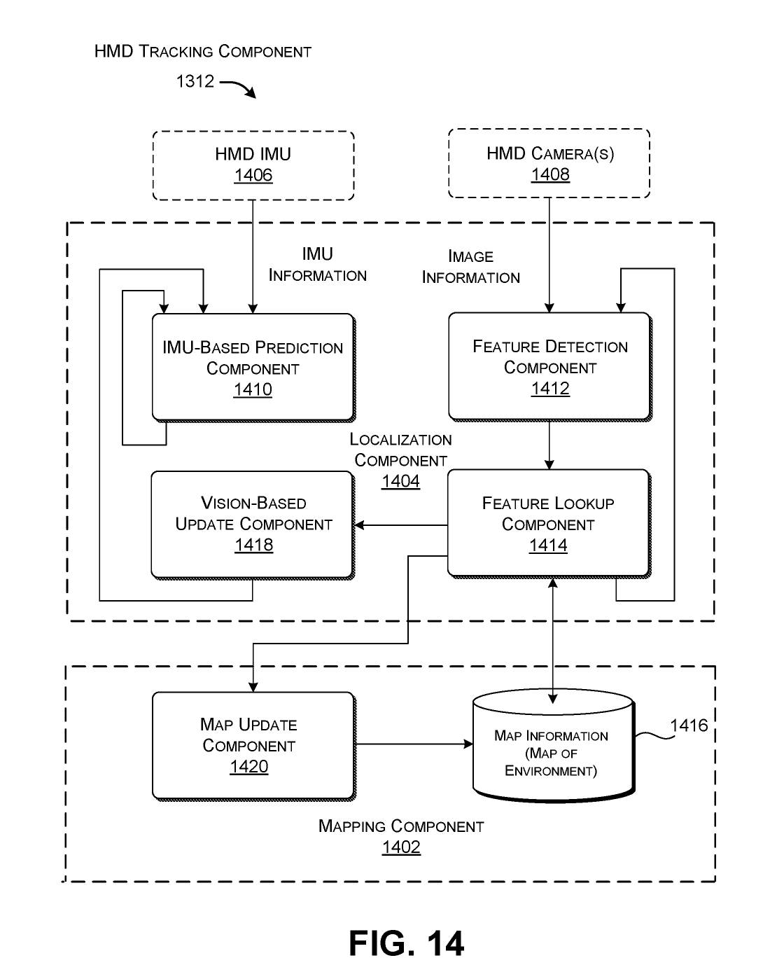

FIG. 14 shows one implementation of the tracking component 1312 of the HMD 106. The tracking component 1312 uses a simultaneous location and mapping (SLAM) technique for use in determining the pose of the HMD 106. In some cases, tracking component 1312 includes a map-building component 1402 and a localization component 1404. The map-building component 1402 builds map information (a “map”) that represents the physical environment, while the localization component 1404 tracks the pose of the HMD 106 with respect to the map information. The map-building component 1402 operates on the basis of image information provided by HMD cameras 1408. The localization component 1404 operates on the basis of the image information provided by the HMD cameras 1408 and IMU information provided by an HMD IMU 1406.

More specifically, beginning with the localization component 1404, an IMU-based prediction component 1410 predicts the pose of the HMD 106 based on a last estimate of the pose in conjunction with the movement information provided by the HMD IMU 1406. For instance, the IMU-based prediction component 1410 can integrate the movement information provided by the HMD IMU 1406 since the pose was last computed, to provide a movement delta value. The movement delta value reflects a change in the pose of the HMD 106 since the pose was last computed. The IMU-based prediction component 1410 can add this movement delta value to the last estimate of the pose, to thereby update the pose.

A feature detection component 1412 determines features in the image information provided by the HMD cameras 1408. For example, the feature detection component 1412 can use any kind of image operation to perform this task. For instance, the feature detection component 1412 can use a Scale-Invariant Feature Transform (SIFT) operator to identify features in the image information. A feature lookup component 1414 determines whether the features identified by the feature detection component 1412 match any previously stored features in the current map information (as provided in a data store 1416).

A vision-based update component 1418 updates the pose of the HMD 106 on the basis of any features discovered by the feature lookup component 1414. In one approach, the vision-based update component 1418 can determine the presumed pose of the HMD 106 through triangulation or some other position-determining technique. The vision-based update component 1418 performs this operation based on the known locations of two or more currently-detected features in the image information (as detected by the feature detection component 1412). A location of a detected feature is known when that feature has been detected on a prior occasion, and the estimated location of that feature has been stored in the data store 1416.

In one mode of operation, the IMU-based prediction component 1410 operates at a first rate, while the vision-based update component 1418 operates at a second rate, where the first rate is greater than the second rate. The localization component 1404 can opt to operate in this mode because the computations performed by the IMU-based prediction component 1410 are significantly less complex than the operations performed by the vision-based update component 1418 (and the associated feature detection component 1412 and feature lookup component 1414). But the predictions generated by the IMU-based prediction component 1410 are more susceptible to error and drift compared to the estimates of the vision-based update component 1418. Hence, the processing performed by the vision-based update component 1418 serves as a correction to the less complex computations performed by the IMU-based prediction component 1410.

Now referring to the map-building component 1402, a map update component 1420 adds a new feature to the map information (in the data store 1416) when the feature lookup component 1414 determines that a feature has been detected that has no matching counterpart in the map information. The map update component 1420 can also store the position of the feature, with respect to the world coordinate system.

In one implementation, the localization component 1404 and the map-building component 1402 can use an Extended Kalman Filter (EFK) to perform the SLAM operations. An EFK maintains map information in the form of a state vector and a correlation matrix. In another implementation, the localization component 1404 and the map-building component 1402 can use a Rao-Blackwellised filter to perform the SLAM operations.

Information regarding the general topic of SLAM per se can be found in various sources, such as Durrant-Whyte, et al., “Simultaneous Localisation and Mapping (SLAM): Part I The Essential Algorithms,” in IEEE Robotics & Automation Magazine, Vol. 13, No. 2, July 2006, pp. 99-110, and Bailey, et al., “Simultaneous Localization and Mapping (SLAM): Part II,” in IEEE Robotics & Automation Magazine, Vol. 13, No. 3, September 2006, pp. 108-117.

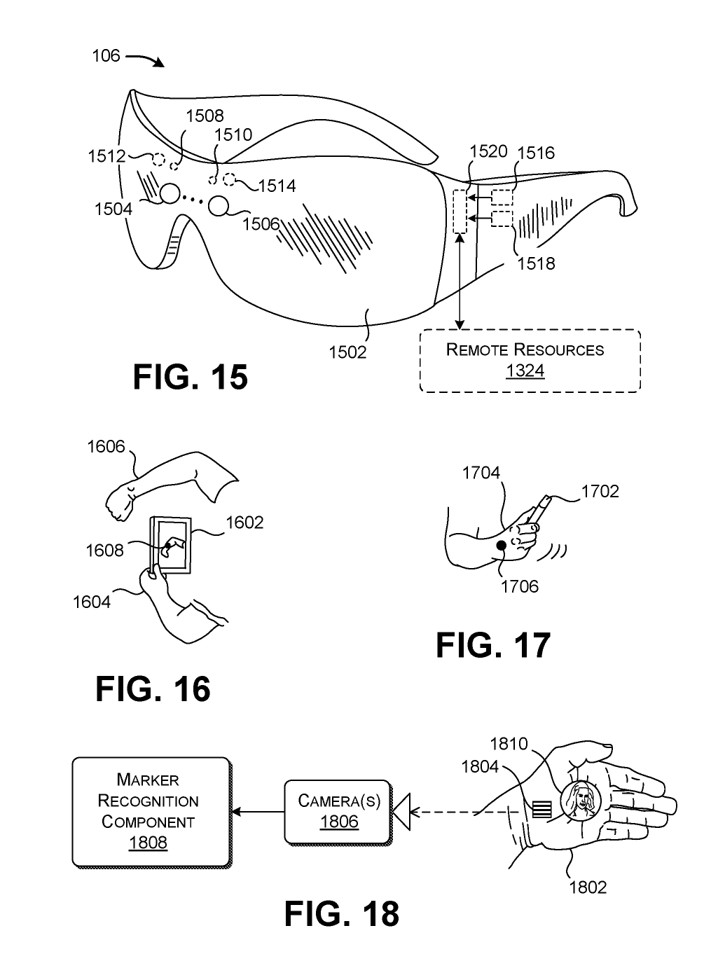

FIG. 15 shows illustrative and non-limiting structural aspects of the HMD 106. The HMD 106 includes a head-worn frame that houses or otherwise affixes a display device 1502, e.g., corresponding to a see-through display device or an opaque (non-see-through) display device. Waveguides (not shown) or other image information conduits direct left-eye images to the left eye of the user 104 and direct right-eye images to the right eye of the user 104, to overall create the illusion of depth through the effect of stereopsis. Although not shown, the HMD 106 can also include speakers for delivering sounds to the ears of the user 104.

The HMD 106 can include any environment-facing imaging components, such as representative environment-facing imaging components 1504 and 1506. The imaging components (1504, 1506) can include RGB cameras, monochrome cameras, a depth camera system (including an illumination source), etc. While FIG. 15 shows only two imaging components (1504, 1506), the HMD 106 can include any number of such components.

The HMD 106 can optionally include an inward-facing gaze-tracking system. For example, the inward-facing gaze-tracking system can include light sources (1508, 1510) for directing light onto the eyes of the user 104, and cameras (1512, 1514) for detecting the light reflected from the eyes of the user 104.

The HMD 106 can also include other input mechanisms, such as one or more microphones 1516, an inertial measurement unit (IMU) 1518, etc. As explained above, the IMU 1518 can include one or more accelerometers, one or more gyroscopes, one or more magnetometers, etc., or any combination thereof.

A control engine 1520 can include logic for performing any of the tasks described above in FIG. 13. The control engine 1520 may optionally interact with the remote resources 1324 via the communication component 1328 (shown in FIG. 13), and/or the local resources 1326.

A.7. Illustrative Variations

The computing environment 102 can be modified in various ways. This subsection identifies three illustrative variations of the computing environment 102. Beginning with FIG. 16, this figure shows a portable computing device 1602 that can be used to render a mixed-reality experience, instead of the HMD 106 shown in FIG. 1, or in addition to the HMD 106. The portable computing device 1602 may correspond to a smartphone, a tablet-type computing device, or some other portable device. The portable computing device 1602 includes one or more cameras on a first side and a display device on the opposing side. The portable computing device 1602 can also implement all of the processing components shown in FIG. 13, or a subset thereof.

In operation, the user 104 may point the camera(s) of the portable computing device 1602 at a body part in which a virtual object is expected to appear. For instance, the user 104 may use his left hand 1604 to point the camera(s) at the user's right forearm 1606 based on knowledge that a virtual object appears at this location. The VEG component 120 and VEP component 124 then cooperate to present a mixed-reality presentation in which a virtual object 1608 appears on the user's right forearm 1606, such as an icon associated with a particular person. The portable computing device's display device presents this mixed-reality scene as long as the user 104 points the portable computing device 1602 at the forearm 1606.

FIG. 17 shows an alternative mechanism for identifying at least some body parts of the user 104, instead of, or in addition to, the skeleton generator component 114 of FIG. 8. In this case, the user 104 manipulates a controller 1702 with his or her hand 1704 while wearing the HMD 106. The HMD 106 detects the position of the controller 1702 based on electromagnetic radiation and/or magnetic fields emitted by the controller 1702. The VEP component 124 and the VEP component 124 then cooperate to display a virtual object 1706 (via the HMD 106) in physical relation to the position of the controller 1702, such as on the back of the user's hand 1704 that manipulates the controller 1702, at a fixed distance from the position of the controller 1702.

FIG. 18 shows yet another mechanism for identifying at least some body parts of the user 104, instead of, or in addition to, the skeleton generator component 114 of FIG. 8. In this case, the user's palm 1802 contains a physical marker 1804, such as a stick-on label having a predetermined pattern and/or a predetermined shape, etc. One or more cameras 1806 capture image information that includes a presentation of the marker 1804. A marker recognition component 1808, which may be part of the tracking component 1312 of the HMD 106, detects the position of the marker 1804 based on the image information. The VEP component 118 and the VEP component 124 then cooperate to display a virtual object 1810 (via the HMD 106) in physical relation to the position of the marker 1804, such as on the user's palm 1802, at an offset of a few centimeters from the location of the marker 1804.

These variations are presented in the spirit of illustration, not limitation; other implementations can include additional variations not set forth above.

B. Illustrative Processes

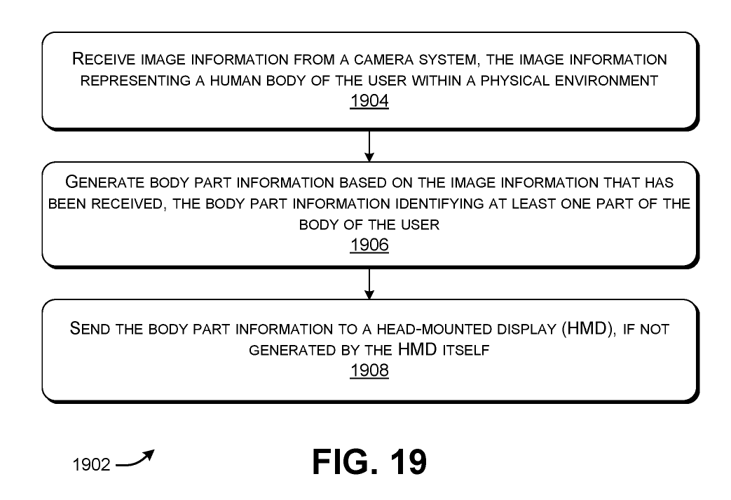

FIGS. 19-21 show a processes that explain the operation of the computing environment 102 of Section A in flowchart form. Since the principles underlying the operation of the computing environment 102 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

FIG. 19 is a flowchart that shows an illustrative process 1902 performed by the skeleton generator component 114 of FIG. 8. In block 1904, the skeleton generator component 114 receives image information from the camera system 110. The image information represents a human body of the user 104 within a physical environment. In block 1906, the skeleton generator component 114 generates body part information based on the image information that has been received. The body part information identifies at least one part of the body of the user 104. In block 1908, in those cases in which the skeleton generator component 114 is separate from the HMD 106, the skeleton generator component 114 sends the body part information to the HMD 106.

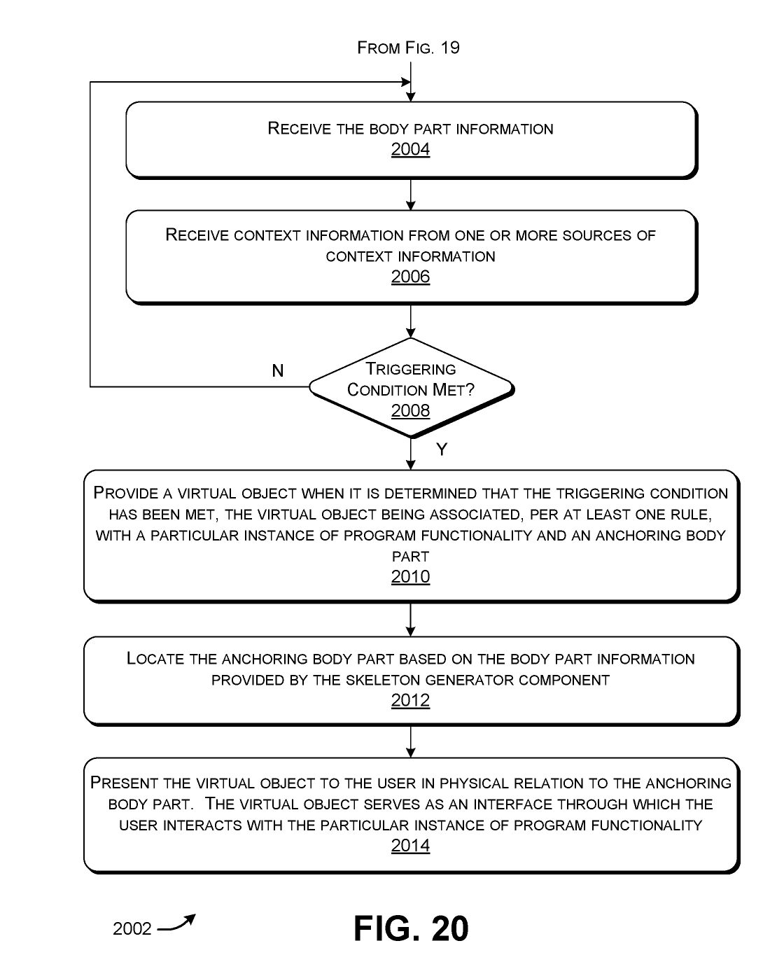

FIG. 20 is a flowchart that shows an illustrative process 2002 performed by the VEG component 120 and the VEP component 124. In block 2004, the VEG component 120 receives the body part information from the skeleton generator component 114. In block 2006, the VEG component 120 receives context information from one or more sources of context information. In block 2008, the VEG component 120 determines, based on the context information, and based on at least one rule specified in the data store 118, whether a triggering condition has been met. In block 2010, the VEG component 120 provides a virtual object when it is determined that the triggering condition has been met. That virtual object is, per the rule(s), associated with a particular instance of program functionality 108 and an anchoring body part. In block 2012, the VEP component 124 locates the anchoring body part based on the body part information provided by the skeleton generator component 114. In block 2014, the VEP component 124 presents the virtual object to the user 104 in physical relation to the anchoring body part. The virtual object serves as an interface through which the user 104 interacts with the particular instance of program functionality 108. The verb “presents” here encompasses any way of manifesting the virtual object, including by providing a visual manifestation, an audible manifestation, and/or some other manifestation(s).

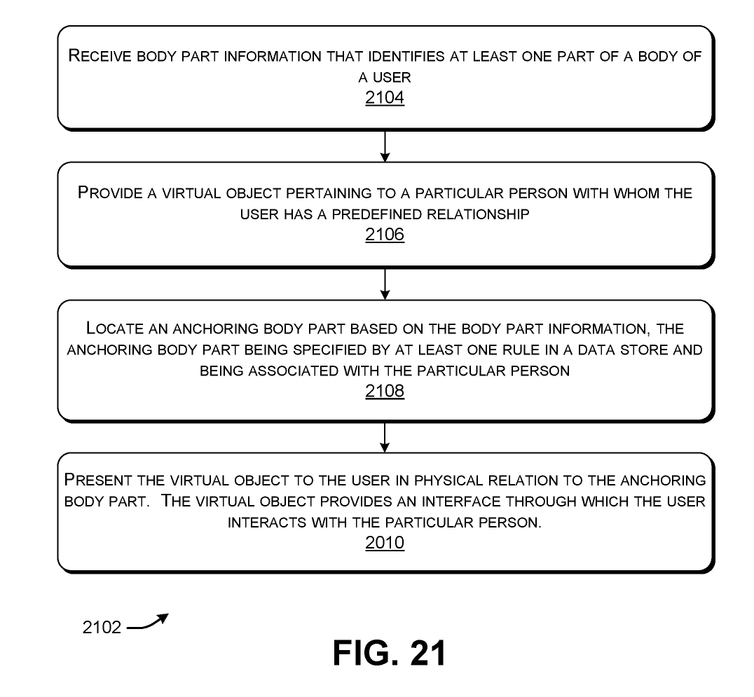

FIG. 21 is a flowchart that shows another process 2102 performed by the VEG component 120 and the VEP component 124. In block 2104, the VEG component 120 receives body part information that identifies at least one part of a body of a user 104. In block 2106, the VEG component 120 provides a virtual object pertaining to a particular person with whom the user 104 has a predefined relationship. In block 2108, the VEP component 124 locates an anchoring body part based on the body part information, the anchoring body part being specified by at least one rule in a data store and being associated with the particular person. In block 2110, the VEP component 124 presents the virtual object to the user 104 in physical relation to the anchoring body part. The virtual object provides a virtual experience to a user 104 in cooperation with the program functionality 108.

C. Representative Computing Device

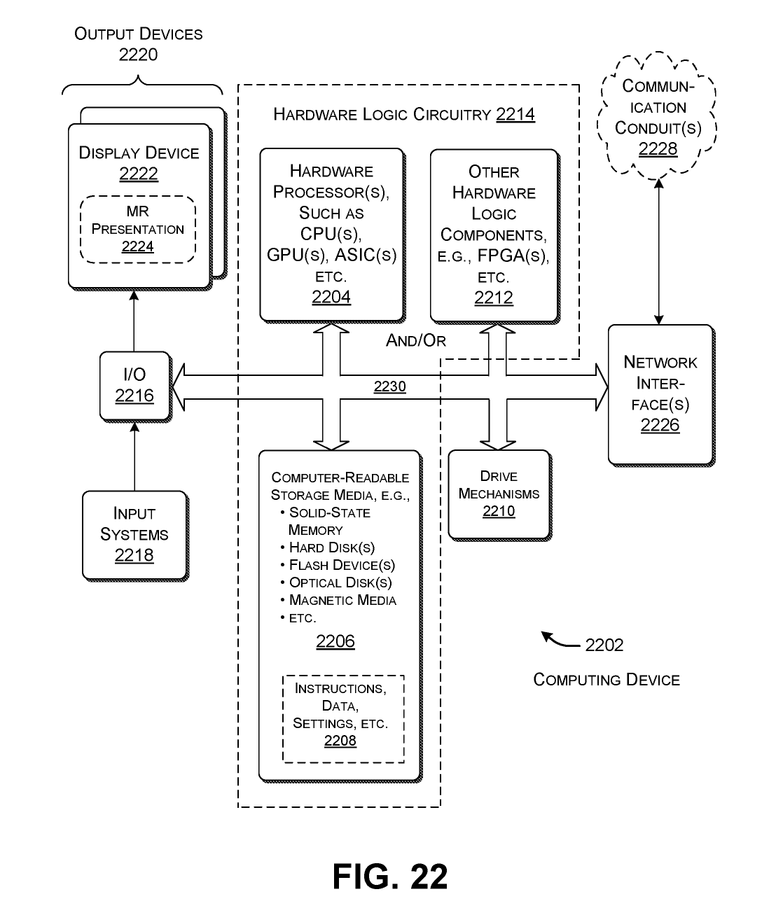

FIG. 22 shows a computing device 2202 that can be used to implement any aspect of the mechanisms set forth in the above-described figures. For instance, the type of computing device 2202 shown in FIG. 22 can be used to implement any processing-related aspects of any of the components shown in FIG. 1. For example, the type of computing device 2202 can be used to implement the HMD 106 and whatever device implements the skeleton generator component 114. In all cases, the computing device 2202 represents a physical and tangible processing mechanism.

The computing device 2202 can include one or more hardware processors 2204. The hardware processor(s) can include, without limitation, one or more central processing units (CPUs), and/or one or more graphics processing units (GPUs), and/or one or more application specific integrated circuits (ASICs), etc. More generally, any hardware processor can correspond to a general-purpose processing unit or an application-specific processor unit.

The computing device 2202 can also include computer-readable storage media 2206, corresponding to one or more computer-readable media hardware units. The computer-readable storage media 2206 retains any kind of information 2208, such as machine-readable instructions, settings, data, etc. Without limitation, for instance, the computer-readable storage media 2206 may include one or more solid-state devices, one or more magnetic hard disks, one or more optical disks, magnetic tape, and so on. Any instance of the computer-readable storage media 2206 can use any technology for storing and retrieving information. Further, any instance of the computer-readable storage media 2206 may represent a fixed or removable component of the computing device 2202. Further, any instance of the computer-readable storage media 2206 may provide volatile or non-volatile retention of information.

The computing device 2202 can utilize any instance of the computer-readable storage media 2206 in different ways. For example, any instance of the computer-readable storage media 2206 may represent a hardware memory unit (such as random access memory (RAM)) for storing transient information during execution of a program by the computing device 2202, and/or a hardware storage unit (such as a hard disk) for retaining/archiving information on a more permanent basis. In the latter case, the computing device 2202 also includes one or more drive mechanisms 2210 (such as a hard drive mechanism) for storing and retrieving information from an instance of the computer-readable storage media 2206.

The computing device 2202 may perform any of the functions described above when the hardware processor(s) 2204 carry out computer-readable instructions stored in any instance of the computer-readable storage media 2206. For instance, the computing device 2202 may carry out computer-readable instructions to perform each block of the processes described in Section B.

Alternatively, or in addition, the computing device 2202 may rely on one or more other hardware logic components 2212 to perform operations using a task-specific collection of logic gates. For instance, the hardware logic component(s) 2212 may include a fixed configuration of hardware logic gates, e.g., that are created and set at the time of manufacture, and thereafter unalterable. Alternatively, or in addition, the other hardware logic component(s) 2212 may include a collection of programmable hardware logic gates that can be set to perform different application-specific tasks. The latter category of devices includes, but is not limited to, programmable array logic devices (PALs), generic array logic devices (GALs), complex programmable logic devices (CPLDs), field-programmable gate arrays (FPGAs), etc.

FIG. 22 generally indicates that hardware logic circuitry 2214 corresponds to any combination of the hardware processor(s) 2204, the computer-readable storage media 2206, and/or the other hardware logic component(s) 2212. That is, the computing device 2202 can employ any combination of the hardware processor(s) 2204 that execute machine-readable instructions provided in the computer-readable storage media 2206, and/or one or more other hardware logic component(s) 2212 that perform operations using a fixed and/or programmable collection of hardware logic gates.

The computing device 2202 also includes an input/output interface 2216 for receiving various inputs (via input systems 2218), and for providing various outputs (via output devices 2220). Illustrative input systems and output devices where described above with reference to FIG. 13. One particular output device may include a display device 2222 associated with the HMD 106. The display device 2222 presents a mixed-reality (MR) presentation 2224. The computing device 2202 can also include one or more network interfaces 2226 for exchanging data with other devices via one or more communication conduits 2228. One or more communication buses 2230 communicatively couple the above-described components together.

The communication conduit(s) 2228 can be implemented in any manner, e.g., by a local area computer network, a wide area computer network (e.g., the Internet), point-to-point connections, etc., or any combination thereof. The communication conduit(s) 2228 can include any combination of hardwired links, wireless links, routers, gateway functionality, name servers, etc., governed by any protocol or combination of protocols.

FIG. 22 shows the computing device 2202 as being composed of a discrete collection of separate units. In some cases, the collection of units may correspond to discrete hardware units provided in a computing device chassis having any form factor. In other cases, the computing device 2202 can include a hardware logic component that integrates the functions of two or more of the units shown in FIG. 1. For instance, the computing device 2202 can include a system on a chip (SoC or SOC), corresponding to an integrated circuit that combines the functions of two or more of the units shown in FIG. 22.

The following summary provides a non-exhaustive set of illustrative aspects of the technology set forth herein.

According to a first aspect, one or more computing devices for providing a mixed-reality experience to a user are described. The computing device(s) includes a skeleton generator component configured to: receive image information from a camera system, the image information representing a human body of the user within a physical environment; and generate body part information based on the image information that has been received, the body part information identifying at least one part of the body of the user. The computing device(s) also includes a data store that provides rules for controlling the presentation one or more virtual objects in relation to respective body parts, each virtual object being associated with an instance of program functionality. The computing device(s) also includes a virtual experience generator component configured to: receive context information from one or more sources of context information; determine, based on the context information, and based on at least one rule specified in the data store, whether a triggering condition has been met; and provide a virtual object when it is determined that the triggering condition has been met, that virtual object being associated, per the aforementioned at least one rule, with a particular instance of program functionality and an anchoring body part. The computing device(s) also includes a virtual experience presentation component configured to: locate the anchoring body part based on the body part information provided by the skeleton generator component; and present the virtual object to the user in physical relation to the anchoring body part. The virtual object provides a virtual experience to a user in cooperation with the particular instance of program functionality. The skeleton generator component, the virtual experience generator component, and the virtual experience presentation component correspond to hardware logic circuitry. The hardware logic circuitry, in turn, corresponds to: (a) one or more hardware processors that perform operations by executing machine-readable instructions stored in a memory, and/or by (b) one or more other hardware logic components that perform operations using a task-specific collection of logic gates.

According to a second aspect, the virtual experience generator component and the virtual experience presentation component are implemented, at least in part, by a head-mounted display (HMD).

According to a third aspect (dependent on the second aspect), the camera system and the skeleton generator component are implemented by at least one external device, the external device(s) being separate from the HMD.

According to a fourth aspect (dependent on the second aspect), the camera system and the skeleton generator component are implemented by the HMD.

According to a fifth aspect, the aforementioned at least one rule instructs the virtual experience generator component to generate the virtual object when it is determined that the user has performed an identified gesture.

According to a sixth aspect, the aforementioned at least one rule instructs the virtual experience presentation component to present the virtual object in a first presentation state when the context information identifies a first context condition, and present the virtual object in a second presentation state when the context information identifies a second context condition, the first presentation state differing from the second presentation state with respect to a location and/or appearance of the virtual object.

According to a seventh aspect, the aforementioned at least one rule identifies a set of persons besides the user that are given rights to consume the virtual object.

According to an eighth aspect, the virtual object is composed of a skin component and a base component, the skin component defining an appearance of the virtual object and the base component defining functionality associated with the virtual object. Further, the aforementioned at least one rule instructs the virtual experience presentation component to present the virtual object using a specified skin component.

According to a ninth aspect, the virtual object is also associated with a particular person with whom the user has a predefined relationship, and wherein the virtual object provides an interface by which the user interacts with the particular person.

According to a tenth aspect (dependent on the ninth aspect), the virtual object corresponds to an icon associated with the particular person.

According to an eleventh aspect (dependent on the ninth aspect), the virtual object is associated with a set of people with whom the user has predetermined relations, the set including the particular person.

According to a twelfth aspect (dependent on the ninth aspect), the virtual object conveys a message sent to the user by the particular person.

According to a thirteenth aspect (dependent on the ninth aspect), the virtual object serves as an interface by which the user sends information to the particular person.

According to a fourteenth aspect, the virtual experience generator component is also configured to detect when the user and/or another person interacts with the virtual object.

According to a fifteenth aspect, the virtual object enables the user to perform a function via the anchoring body part, in cooperation with the particular instance of program functionality, but the virtual object has no visible or audio component.

According to a sixteenth aspect, a method is described for or providing a mixed-reality experience to a user. The method includes receiving body part information from a skeleton generator component. The skeleton generator component generates the body part information based on image information received from a camera system. The image information represents a human body of the user within a physical environment. The body part information identifies at least one part of the body of the user. The method also includes: receiving context information from one or more sources of context information; determining, based on the context information, and based on at least one rule specified in a data store, whether a triggering condition has been met; providing a virtual object when it is determined that the triggering condition has been met, the virtual object being associated, per the aforementioned at least one rule, with a particular instance of program functionality and an anchoring body part; locating the anchoring body part based on the body part information; and presenting the virtual object to the user in physical relation to the anchoring body part. The virtual object serves as an interface through which the user interacts with the particular instance of program functionality. The method is implemented by one or more computing devices.

According to a seventeenth aspect, the method is performed, at least in part, by a head-mounted display (HMD).

According to an eighteenth aspect (dependent on the sixteenth aspect), the virtual object is also associated with a particular person with whom the user has a predefined relationship, wherein the virtual object provides an interface by which the user interacts with the particular person.

According to a nineteenth aspect, a computer-readable storage medium is described for storing computer-readable instructions. The computer-readable instructions, when executed by one or more hardware processors, perform a method that includes: receiving body part information that identifies at least one part of a body of a user; providing a virtual object pertaining to a particular person with whom the user has a predefined relationship; locating an anchoring body part based on the body part information, the anchoring body part being specified by at least one rule in a data store and being associated with the particular person; and presenting the virtual object to the user in physical relation to the anchoring body part. The virtual object provides an interface through which the user interacts with the particular person.

According to a twentieth aspect (dependent on the nineteenth aspect), the virtual object includes an icon that represents the particular person.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computing devices for providing a mixed-reality experience to a user, comprising:
a skeleton generator component configured to:
receive image information from a camera system, the image information representing a human body of the user within a physical environment; and
generate body part information based on the image information that has been received, the body part information identifying at least one part of the body of the user;
a data store that provides rules for controlling the presentation one or more virtual objects in relation to respective body parts, each virtual object being associated with an instance of program functionality;
a virtual experience generator component configured to:
receive context information from one or more sources of context information;
determine, based on the context information, and based on at least one rule specified in the data store, whether a triggering condition has been met; and
provide a virtual object when it is determined that the triggering condition has been met, that virtual object being associated, per said at least one rule, with a particular instance of program functionality and an anchoring body part; and
a virtual experience presentation component configured to:
locate the anchoring body part based on the body part information provided by the skeleton generator component; and
present the virtual object to the user in physical relation to the anchoring body part,
the virtual object providing a virtual experience to a user in cooperation with the particular instance of program functionality,
the skeleton generator component, the virtual experience generator component, and the virtual experience presentation component corresponding to hardware logic circuitry,
the hardware logic circuitry corresponding to: (a) one or more hardware processors that perform operations by executing machine-readable instructions stored in a memory, and/or by (b) one or more other hardware logic components that perform operations using a task-specific collection of logic gates.

2. The one or more computing devices of claim 1, wherein the virtual experience generator component and the virtual experience presentation component are implemented, at least in part, by a head-mounted display (HMD).

3. The one or more computing devices of claim 2, wherein the camera system and the skeleton generator component are implemented by at least one external device, said at least one external device being separate from the HMD.

4. The one or more computing devices of claim 2, wherein the camera system and the skeleton generator component are implemented by the HMD.

5. The one or more computing devices of claim 1, wherein said at least one rule instructs the virtual experience generator component to generate the virtual object when it is determined that the user has performed an identified gesture.

6. The one or more computing devices of claim 1, wherein said at least one rule instructs the virtual experience presentation component to present the virtual object in a first presentation state when the context information identifies a first context condition, and present the virtual object in a second presentation state when the context information identifies a second context condition, the first presentation state differing from the second presentation state with respect to a location and/or appearance of the virtual object.

7. The one or more computing devices of claim 1, wherein said at least one rule identifies a set of persons besides the user that are given rights to consume the virtual object.

8. The one or more computing devices of claim 1,
wherein the virtual object is composed of a skin component and a base component, the skin component defining an appearance of the virtual object and the base component defining functionality associated with the virtual object, and
wherein said at least one rule instructs the virtual experience presentation component to present the virtual object using a specified skin component.

9. The one or more computing devices of claim 1, wherein the virtual object is also associated with a particular person with whom the user has a predefined relationship, and wherein the virtual object provides an interface by which the user interacts with the particular person.

10. The one or more computing devices of claim 9, wherein the virtual object corresponds to an icon associated with the particular person.

11. The one or more computing devices of claim 9, wherein the virtual object is associated with a set of people with whom the user has predetermined relations, the set including the particular person.

12. The one or more computing devices of claim 9, wherein the virtual object conveys a message sent to the user by the particular person.

13. The one or more computing devices of claim 9, wherein the virtual object serves as an interface by which the user sends information to the particular person.

14. The one or more computing devices of claim 1, wherein the virtual experience generator component is also configured to detect when the user and/or another person interacts with the virtual object.

15. The one or more computing devices of claim 1, wherein the virtual object enables the user to perform a function via the anchoring body part, in cooperation with the particular instance of program functionality, but the virtual object has no visible or audio component.

16. A method for or providing a mixed-reality experience to a user, comprising:
receiving body part information from a skeleton generator component, the skeleton generator component generating the body part information based on image information received from a camera system, the image information representing a human body of the user within a physical environment, and the body part information identifying at least one part of the body of the user;
receiving context information from one or more sources of context information;
determining, based on the context information, and based on at least one rule specified in a data store, whether a triggering condition has been met;
providing a virtual object when it is determined that the triggering condition has been met, the virtual object being associated, per said at least one rule, with a particular instance of program functionality and an anchoring body part;
locating the anchoring body part based on the body part information; and
presenting the virtual object to the user in physical relation to the anchoring body part,
the virtual object serving as an interface through which the user interacts with the particular instance of program functionality,
the method being implemented by one or more computing devices.

17. The method of claim 16, wherein the method is performed, at least in part, by a head-mounted display (HMD).

18. The method of claim 16, wherein the virtual object is also associated with a particular person with whom the user has a predefined relationship, and wherein the virtual object provides an interface by which the user interacts with the particular person.

19. A computer-readable storage medium for storing computer-readable instructions, the computer-readable instructions, when executed by one or more hardware processors, performing a method that comprises:
receiving body part information that identifies at least one part of a body of a user;
providing a virtual object pertaining to a particular person with whom the user has a predefined relationship;
locating an anchoring body part based on the body part information, the anchoring body part being specified by at least one rule in a data store and being associated with the particular person; and
presenting the virtual object to the user in physical relation to the anchoring body part,
the virtual object providing an interface through which the user interacts with the particular person.

20. The machine-readable storage medium of claim 19, wherein the virtual object includes an icon that represents the particular person.
